(19) United States
(12) Patent Application Publication
(10) Pub. No.: US 2025/0010746 A1
(43) Pub. Date: Jan. 9, 2025

(54) CHARGING DEVICE FOR A VEHICLE, AND VEHICLE

(71) Applicant: FORD GLOBAL TECHNOLOGIES, LLC, Dearborn, MI (US)

(72) Inventors: Guenter Hans GROSCH, Vettweiss (DE); Georg LOUVEN, Neuwied (DE); Rainer KIEHN, Frechen (DE); Krystian DYLONG, Cologne (DE); Torsten Hans-Jakob SPUERCK, Bergisch Gladbach (DE)

(73) Assignee: FORD GLOBAL TECHNOLOGIES, LLC, Dearborn, MI (US)

(21) Appl. No.: 18/763,038

(22) Filed: Jul. 3, 2024

(30) Foreign Application Priority Data
Jul. 3, 2023 (DE) 102023117527.0

(51) Int. Cl. B60L 53/36; B60L 53/38

(52) U.S. Cl. CPC B60L 53/36; B60L 53/38

(57) ABSTRACT

A charging device for a primary vehicle configured for charging a secondary vehicle comprises at least one repositionable coupling element. The at least one coupling element is repositionable such that it can be positioned correspondingly in relation to a coupling element of a charging device of the secondary vehicle. The charging device is set up to ensure an inductive charging process between the primary vehicle and the secondary vehicle using the coupling element.

### CROSS-REFERENCE TO RELATED APPLICATIONS

This application claims foreign priority benefits under 35 U.S.C. § 119(a)-(d) to DE Application 10 2023 117 527.0 filed Jul. 3, 2023, which is hereby incorporated by reference in its entirety.

### TECHNICAL FIELD

The present disclosure relates generally to a charging device for a vehicle, and to a vehicle.

### BACKGROUND

Electrified vehicles with at least partial electric drive have an energy storage device, such as a traction battery, to provide propulsive force for the vehicle that must be charged regularly so that the electric drive can be used. In hybrid vehicles, this can be done in part by using the combustion engine to provide electrical charge for storage in the energy storage device.

Regardless of whether it is a hybrid vehicle or a vehicle with only an electric drive, the vehicle's energy storage device may have such a low state of charge that the vehicle can no longer be powered by the electric drive. In the case of hybrid vehicles, this condition may be accompanied by a fuel tank level that is also insufficient to operate the hybrid vehicle by means of the combustion engine.

In these situations, the vehicle previously had to be towed to a charging station or filling station. Alternatively, a mobile charger must be brought in to charge the energy storage device at least to the extent that the vehicle can be operated again. However, such mobile chargers are not very common. In addition, both approaches are expensive.

DE 10 2016 014 034 A1 and US 2022/0016987 A1 disclose an inductive charging mechanism in which a coupling element in the front area of a vehicle and a corresponding coupling element in the rear area of a charging vehicle are used for a charging process.

U.S. Pat. No. 9,272,631 B2 discloses a charging device that has inductive charging elements in the area of the vehicle's license plate holder.

U.S. Pat. No. 11,014,464 B2 discloses a charging mechanism that uses a mobile storage device that can be temporarily coupled to a vehicle to transfer electrical charge.

CN 213831558 U discloses a parking license plate device that has an extendable display part.

There is therefore a need to eliminate or at least reduce the disadvantages of known vehicles or their charging mechanisms. In particular, there is a need to create a charging mechanism by means of which a vehicle can be charged independently of the availability of charging stations, filling stations or auxiliary components such as mobile chargers.

### SUMMARY

Advantageous embodiments are described herein and within the scope of one or more claims. Various described embodiments may individually or in (sub-)combination represent aspects of the disclosure.

According to one aspect, some embodiments relate to a charging device for a primary electrified vehicle having an energy store coupled to an electric machine configured to provide propulsive torque for the vehicle. The charging device has at least one repositionable coupling element. The at least one coupling element is repositionable in such a way that it can be positioned correspondingly in relation to a coupling element of a charging device of a secondary electrified vehicle. The charging device is set up to ensure an inductive charging process between the primary electrified vehicle and the secondary electrified vehicle using the coupling element.

Inductive charging processes are based on magnetic fields in which the efficiency of the energy transfer is largely determined by the distance and relative orientation of the components involved. Due to the positionability of the coupling element, the coupling element can be positioned in such a way that it is arranged correspondingly in relation to the coupling element of another charging device. In particular, the distance and the relative orientation between the correspondingly arranged coupling elements can be optimized in order to maximize the efficiency of the energy transfer. Advantageously, the charging device is designed as part of the vehicle and is therefore inherently available. This enables particularly efficient charging processes that are independent of whether other charging infrastructures are available, such as mobile chargers. The charging device designed in this way also creates independence from charging connection types for wired charging mechanisms. For example, charging devices of the present disclosure can therefore be particularly helpful for breakdown vehicles, as they then have to take fewer different charging connection types into account.

The repositionability of the coupling element in the present case means that the coupling element can be moved or is movable during an operating state of the primary vehicle. The operating state can, for example, be a parked state of the primary vehicle. This means that the repositionability of the coupling element is not to be understood in such a way that the coupling element can be positioned in different positions as a result of a maintenance activity. Rather, the repositionability of the coupling element represents a specialized operating function of the primary vehicle.

In the present case, an inductive charging process is to be understood in particular as a charging process that does not require a closed conductor for current transmission. This means that two conductors are not coupled together to form a common conductor for current transmission. Rather, the inductive charging process is based on the fact that energy is transmitted at least in portions without a structurally formed conductor (more precisely, an induction current is caused, based on which electrical charge can be obtained).

The corresponding position of coupling elements of the primary vehicle and the secondary vehicle can be such that the correspondingly positioned coupling elements have a predetermined distance and a predetermined relative orientation to one another. In particular, the correspondingly positioned coupling elements can be arranged opposite each other.

Alternatively, the corresponding position of the coupling elements can also be such that the coupling elements are arranged adjacently to each other. In other words, the corresponding position can also be accompanied by direct contact between the coupling elements.

Optionally, the repositionable coupling element is movable at least between a standard position and an exposed position. In the exposed position, the coupling element has a predefined minimum distance to the closest portion of the body of the primary vehicle. The minimum distance to the rest of the body of the primary vehicle can ensure a buffer zone to prevent contact between the secondary vehicle and the rest of the body of the primary vehicle. The buffer zone is substantially given by the distance between the standard position and the exposed position of the coupling element. The repositionable coupling element has at least one inductive component. This enables the generation of a magnetic field intended for energy transmission in a compact manner. Optionally, the inductive component can be a passive component. This has the advantage of reducing the requirements on the underlying electronic circuit.

In particular, the inductive passive component can comprise a magnetic coil. A magnetic coil can advantageously provide a magnetic field with a desired spatial orientation. This enables a spatially directed energy transfer that corresponds to the corresponding positions of the coupling elements of the primary vehicle and the secondary vehicle. As a further advantage, a magnetic coil can be used both to generate a magnetic field and to induce a current based on an external magnetic field. In other words, a magnetic coil facilitates using the coupling element both as an energy transmitter (magnetic-field-generating element) and as an energy receiver (magnetic-field-receiving element in which a current is induced). This means that the coupling element can transmit and receive energy bidirectionally.

In some embodiments, the charging device is coupled to an energy storage device of the primary vehicle. In this way, a state of charge of the energy storage device of the primary vehicle can be varied using the charging device. In particular, the state of charge of the energy storage device of the primary vehicle can be increased if the charging device of the primary vehicle acts as a receiver. On the other hand, the charging device of the primary vehicle can also serve as a transformer and thus can be used to increase the state of charge of energy storage devices of other vehicles. This reduces the state of charge of the energy storage device of the primary vehicle.

Preferably, the repositionable coupling element is set up to form part of a license plate holder. License plate holders usually have similar positions in vehicles of different types. As a result, the corresponding positionability of coupling elements of different vehicles can be reliably ensured. Furthermore, the license plate holder is usually a part of the body of a vehicle that is not offset from other parts of the rest of the body in the direction of the center of the vehicle. In other words, the license plate holder typically has a maximum distance from the center of the vehicle, at least relative to surrounding parts of the rest of the body. The license plate holder is therefore particularly well suited for preventing contact between the secondary vehicle and the rest of the body of the primary vehicle.

Optionally, the charging device has at least one actuator by means of which the at least one coupling element can be repositioned. In particular, the actuator is set up to reposition the coupling element between the standard position and the exposed position. This allows the coupling element to be repositioned in a defined manner. The actuator may ensure that the coupling element can move along at least one axis. Optionally, the actuator can also be set up, or several actuators can be provided, in such a way that the coupling element is movable along at least two axes or even three axes individually or in combination, which are oriented orthogonally to one another in pairs in each case (corresponding to a Cartesian coordinate system). In particular, the at least one actuator or the multiple actuators can ensure that the coupling element can be positioned according to an optimized, corresponding position with the coupling element of a secondary vehicle. This maximizes the efficiency of energy transmission.

In some embodiments, the charging device has a control device that is set up to communicate with a charging device of another vehicle. By communicating the charging devices of different vehicles, for example, the positioning of the coupling element can be achieved in such a way that an optimized corresponding position of the coupled coupling elements of the different vehicles is ensured, either automatically by one or more programmed microprocessors, or user-assisted with visual, audio, or haptic feedback in response to strength or efficiency of the coupling for a particular position or range of positions. For example, position data of the participating vehicles or the participating coupling elements can be exchanged (communicated) for this purpose. Furthermore, the communication enables an exchange of information regarding the states of charge of energy storage devices of the participating vehicles. In addition, the communication also enables queries about the possibility or initialization of charging processes between different vehicles. For example, the control device of the charging device can attempt to query a secondary vehicle as to whether the secondary vehicle has a corresponding charging device in order to carry out an inductive charging process. Furthermore, the communication also enables corresponding command transmissions, for example regarding the interruption of a charging process that is taking place, for example because one of the vehicles involved is to be moved. Ultimately, communication makes it possible to control the charging process between participating vehicles as required. Of course, the control device can also be set up to communicate with charging devices of other vehicles, for example to form a charging chain, as explained below. In general, the control device comprises at least one data processing device.

According to a further aspect, some embodiments of the present disclosure also relate to a vehicle having at least one charging device as described above. The advantages achieved by the charging device described above are also achieved correspondingly by the vehicle with the corresponding charging device. In particular, the vehicle is not dependent on the availability of a charging station or a mobile charging device to influence the state of charge of an energy storage device of the vehicle. For the purposes of the present disclosure, vehicles may include, in particular, land vehicles, namely, inter alia, off-road and on-road vehicles such as passenger cars, buses, trucks and other commercial vehicles. Vehicles may be manned or unmanned. In addition to fully electric vehicles (BEV), vehicles can also be hybrid electric vehicles (HEV) and plug-in hybrids (PHEV).

Optionally, a license plate holder of the vehicle comprises the coupling element. The advantages of this have already been explained above. In one or more embodiments, the vehicle has a front license plate holder and a rear license plate holder. The front license plate holder and the rear license plate holder each have a coupling element of a charging device as described above. This compensates for the relative orientation of the primary vehicle in relation to the secondary vehicle. This means that it is irrelevant whether the primary vehicle is positioned in front of the secondary vehicle or whether the primary vehicle is positioned behind the secondary vehicle. In either case, a charging device with a coupling element that is included in a front license plate holder can be coupled with a coupling element of a charging device that is included in a rear license plate holder of another vehicle. In an alternative, the charging devices can also be coupled to one another and have coupling elements that are included on both sides in the respective front license plate holders or the rear license plate holders.

In addition, this embodiment enables the formation of so-called charging chains. For example, a first vehicle can have a low state of charge of an energy storage device. A second vehicle can be arranged adjacent to the first vehicle and has a state of charge of an energy storage device, which may also be insufficient to charge the first vehicle. However, a third vehicle can then be arranged adjacently to the second vehicle, and thus away from the first vehicle, and has a sufficient state of charge of an energy storage device to even increase a state of charge of the first and/or second vehicle. In one example, the second vehicle is optionally only used as an energy transmitter, in which case one charging device acts as a receiver and one charging device acts as a transformer. As a result, a state of charge of the first vehicle can be increased, although the electrical power used for this is provided by the third vehicle, which is located at a distance from the first vehicle and is not inductively coupled directly to the first vehicle. This configuration is particularly advantageous for fleet vehicles, such as cab fleets or the like, as the energy can be distributed across at least part of the fleet. In particular, only a single vehicle in the charging chain can then be coupled to a stationary charging station, wherein the states of charge of the remaining vehicles in the charging chain are increased based on inductive charging processes. As a result, the number of charging stations required can be reduced.

If the vehicle has several charging devices, the charging devices can have a single common control device. This means that the control device can be designed jointly for all of the charging devices of the vehicle.

All of the features described with regard to the various aspects can be combined individually or in (sub-)combinations with other aspects.

The disclosure and further advantageous embodiments and developments thereof are described and explained in greater detail below with reference to the examples shown in the drawings, in which:

### BRIEF DESCRIPTION OF THE DRAWINGS

FIG. 1 shows a simplified schematic representation of a vehicle with a charging device according to an embodiment of the present disclosure,

FIG. 2 shows a simplified schematic representation of charging devices according to an embodiment of the present disclosure, and

FIG. 3 shows a charging chain of vehicles according to an embodiment of the present disclosure.

### DETAILED DESCRIPTION

As required, detailed embodiments of the claimed subject matter are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The following detailed description in conjunction with the accompanying drawings, in which like numerals refer to like elements, is intended as a description of various embodiments of the disclosed subject matter and is not intended to represent the only embodiments. Any embodiment described in this disclosure is merely by way of example or illustration and should not be construed as preferential or advantageous over other embodiments. The illustrative examples contained herein are not intended to be exhaustive and do not limit the claimed subject matter to the precise forms disclosed. Various modifications of the described embodiments will be readily apparent to those skilled in the art, and the general principles defined herein may be applied to other embodiments and applications without departing from the spirit and scope of the described embodiments. Therefore, the described embodiments are not limited to the embodiments shown, but have the widest possible scope of application consistent with the principles and features disclosed herein.

All features disclosed below with respect to the exemplary embodiments and/or accompanying figures may be combined alone or in any sub-combination with features of aspects of the present disclosure, including features of preferred embodiments, provided that the resulting combination of features is expedient to a person skilled in the art.

For the purposes of the present disclosure, the wording “at least one of A, B and C” means, for example, (A), (B), (C), (A and B), (A and C), (B and C) or (A, B and C), including all other possible combinations when more than three elements are listed. In other words, the term “at least one of A and B” generally means “A and/or B”, namely “A” alone, “B” alone or “A and B”.

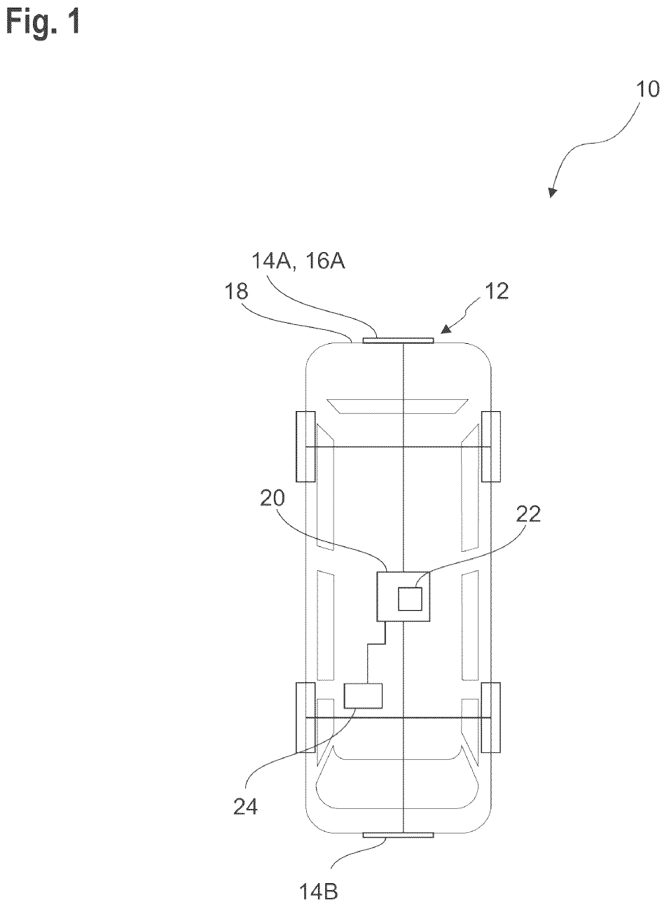

FIG. 1 shows a simplified schematic representation of an electrified vehicle 10 with a charging device 12 electrically coupled to an energy store, such as a traction battery, according to an embodiment of the present disclosure. In the present case, the electrified vehicle 10 comprises two charging devices 12 both electrically coupled to the energy store or storage device. A first charging device 12 is arranged in the front area of the vehicle 10. A second charging device 12 is arranged in the rear area of the vehicle 10. Each charging device 12 comprises a coupling element 14A, 14B, which in the present case is formed as part of a respective license plate holder 16A, 16B. The charging device 12 is set up to reposition the respective coupling element 14A, 14B relative to the rest of the body 18 of the vehicle 10. This means that the respective coupling element 14A, 14B can assume at least a standard position and an exposed position, which differ with respect to their distance from the rest of the body 18 of the vehicle 10.

In the present case, the charging devices 12 of the vehicle 10 have a single, jointly designed control device 20. The control device 20 is coupled to at least both coupling elements 14A, 14B. The control device 20 comprises a data processing device 22. The control device 20 is further coupled to a communication device 24 by means of which the control device 20 can communicate with charging devices 12 of other vehicles 10. In general, each charging device 12 can also have a separate control device 20. In this case, it may be provided that the control devices 20 of different charging devices 12 of the same vehicle 10 can communicate with each other. In an alternative, the communication device 24 can also be designed as an internal component of the control device 20. Each charging device 12 is also coupled to an on-board electrical system of the vehicle 10, and in particular to an energy storage device thereof (not shown here).

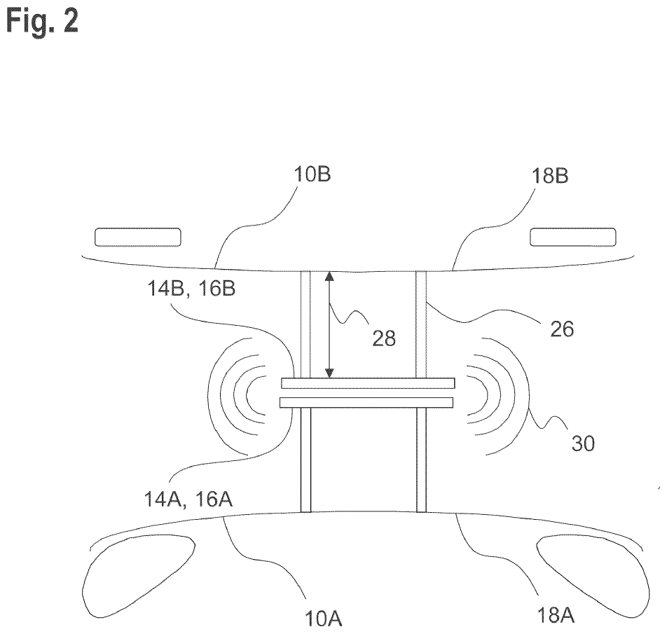

FIG. 2 shows a simplified schematic representation of charging devices 12 according to an embodiment of the present disclosure. The coupling element 14A of the charging device 12 of a first vehicle 10A (primary vehicle) is arranged correspondingly to the coupling element 14B of the charging device 12 of a second vehicle 10B (secondary vehicle). The respective coupling elements 14A, 14B are formed in respective license plate holders 16A, 16B.

Each charging device 12 comprises at least one actuator 26, by means of which the respective coupling element 14 can be repositioned at least along one axis relative to the rest of the body 18 of the respective vehicle 10. In particular, the coupling element 14 can be repositioned relative to the rest of the body 18 in such a way that the coupling element 14 has a minimum distance 28 relative to the rest of the body 18.

At the same time, the actuator 26 is used to position the coupling element 14 in such a way that corresponding positions of the opposing coupling elements 14A, 14B of the different vehicles 10A, 10B are ensured.

One of the coupling elements 14A, 14B then generates a magnetic field 30, which induces a current in the other of the coupling elements 14B, 14A. In this way, energy can be effectively transferred from a primary electrified vehicle 10A to a secondary electrified vehicle 10B.

In an alternative, a charging device 12 may also comprise a plurality of actuators 26 or an actuator that is set up to reposition the coupling element 14 relative to the rest of the body 18 along a plurality of axes oriented orthogonally to each other. This ensures that the coupling elements 14A, 14B can be positioned correspondingly to one another in such a way that the efficiency of the energy transfer meets or exceeds a minimum desired efficiency level, which may vary depending on the particular vehicle application and implementation.

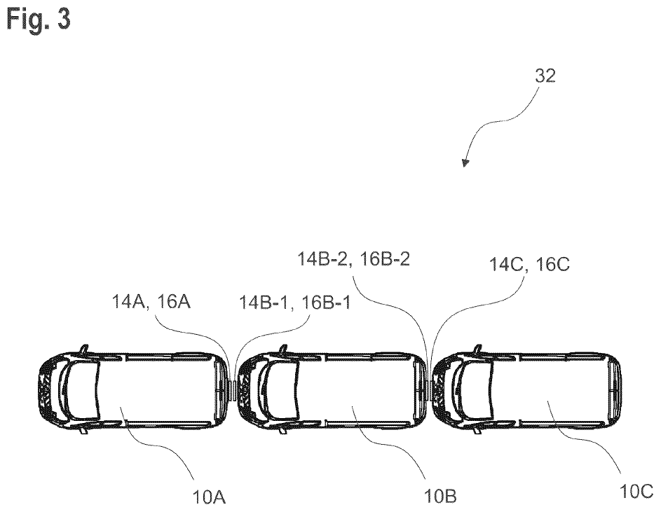

FIG. 3 shows a charging chain 32 of vehicles 10A, 10B, 10C according to an embodiment of the present disclosure. According to this embodiment, the primary vehicle 10A is coupled to the secondary vehicle 10B via the correspondingly arranged coupling elements 14A, 14B-1 in such a way that an inductive charging process can take place between them. Furthermore, the secondary vehicle 10B is coupled to the tertiary vehicle 10C via the coupling elements 14B-2, 14C arranged correspondingly to one another, in such a way that an inductive charging process can take place between them.

The charging chain 32 thus enables energy to be effectively transferred from the primary electrified vehicle 10A to the tertiary electrified vehicle 10C, although these vehicles 10A, 10C are not arranged adjacently to one another and are also not directly coupled to one another via corresponding charging devices 12, but only indirectly via the intermediate secondary electrified vehicle 10B.

In particular, the control device 20 of a vehicle 10 in the case of a charging chain 32, but also in the case of vehicles 10 coupled in pairs, can be set up to ensure appropriate communication between the vehicles 10. For example, the communication device 24 can be used for this purpose. In this way, inductive charging processes can be ensured by the charging devices 12, which can be initiated, monitored, and terminated as required by the corresponding control devices 20.

Certain embodiments disclosed herein, in particular, the control device 20 and the communication device 24 use circuits (e.g. one or more circuits) to implement standards, protocols, methods, or technologies disclosed herein, to operably couple two or more components, generate information, process information, analyze information, generate signals, encode/decode signals, convert signals, transmit and/or receive signals, control other devices, etc. Circuits of any type can be used.

In one embodiment, a circuit such as the control device includes, inter alia, one or more data processing devices such as a processor (e.g. a microprocessor), a central processor unit (CPU), a digital signal processor (DSP), an application-specific integrated circuit (ASIC), a field-programmable gate array (FPGA), a system on a chip (SoC), or the like, or any combinations thereof, and may include discrete digital or analog circuit elements or electronics, or combinations thereof. In one embodiment, the circuit comprises hardware circuit implementations (e.g. analog circuit implementations, digital circuit implementations, and the like, and combinations thereof).

In one embodiment, circuits comprise combinations of circuits and computer program products having software or firmware instructions stored on one or more non-transitory computer-readable memories that cooperate to cause a device to perform one or more of the protocols, methods, or technologies described herein. In one embodiment, the circuitry comprises circuits, such as microprocessors or parts of microprocessors, that require firmware and the like for operation of software. In one embodiment, the circuits comprise one or more processors or parts thereof and the associated software, firmware, hardware and the like.

Unless expressly stated, references to quantities and numbers are not to be regarded as limiting, only as examples in the context of the present application. In this context, the term “plurality” may also be used in the present application to refer to a quantity or number. In this context, the term “plurality” means any number greater than one, e.g., two, three, four, five, etc. The terms “about”, “approximately”, “close to”, etc. mean plus or minus 5% of the stated value.

Although the disclosure has been presented and described with reference to one or more embodiments, a person skilled in the art will be able to make equivalent changes and modifications after reading and understanding this description and the accompanying drawings. The representative embodiments described are not intended to describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments of the claimed subject matter that are not explicitly illustrated or described in combination.

What is claimed is:

1. An electrified vehicle having a traction battery coupled to an electric machine operable to provide propulsive torque for the electrified vehicle, the electrified vehicle comprising:
a charging device electrically coupled to the traction battery and having at least one inductive coupling element, the at least one inductive coupling element repositionable to facilitate positioning relative to a complementary coupling element of a second charging device of a secondary electrified vehicle, the charging device operable to inductively transfer power from the traction battery to the second charging device of the secondary electrified vehicle through the at least one inductive coupling element.

2. The electrified vehicle of claim 1 wherein the at least one coupling element is movable between a retracted position and an extended position.

3. The electrified vehicle of claim 2 wherein the extended position extends away from a body of the electrified vehicle a predetermined minimum distance from all remaining portions of the body of the electrified vehicle.

4. The electrified vehicle of claim 3 wherein the inductive coupling element forms a portion of a vehicle license plate holder.

5. The electrified vehicle of claim 4 wherein the charging device comprises at least one actuator configured to position the inductive coupling element.

6. The electrified vehicle of claim 1 wherein the charging device comprises a controller configured to communicate with the charging device of the second electrified vehicle.

7. The electrified vehicle of claim 1 wherein the inductive coupling element forms a portion of a vehicle license plate holder.

8. The electrified vehicle of claim 7 wherein the vehicle license plate holder is a front license plate holder, the electrified vehicle further comprising a rear charging device having a rear inductive coupling element, wherein the rear inductive coupling element forms a portion of a rear license plate holder of the electrified vehicle.

9. An electrified vehicle comprising:
a traction battery coupled to an electric machine operable to provide propulsive torque for the electrified vehicle; and
a charging device electrically coupled to the traction battery and having at least one inductive coupling element, the at least one inductive coupling element repositionable to facilitate positioning relative to a complementary coupling element of a second charging device of a secondary electrified vehicle, the charging device operable to inductively transfer power from the traction battery to the second charging device of the secondary electrified vehicle through the at least one inductive coupling element, wherein the inductive coupling element forms a portion of a vehicle license plate holder.

10. The electrified vehicle of claim 9 wherein the vehicle license plate holder comprises a front license plate holder, the electrified vehicle further comprising a rear charging device having a rear inductive coupling element, wherein the rear inductive coupling element forms a portion of a rear license plate holder of the electrified vehicle.

11. The electrified vehicle of claim 10 wherein the charging device comprises at least one actuator configured to position the inductive coupling element.

12. The electrified vehicle of claim 11 wherein the at least one actuator is operable to move the at least one inductive coupling element between a retracted position and an extended position.

13. The electrified vehicle of claim 12 wherein the extended position extends away from a body of the electrified vehicle a predetermined minimum distance relative to all remaining portions of the body of the electrified vehicle.

14. The electrified vehicle of claim 13 wherein the charging device comprises a controller configured to communicate with the second charging device of the second electrified vehicle.
